(19) United States
(12) Patent Application Publication
(10) Pub. No.: US 2009/0164220 A1
(43) Pub. Date: Jun. 25, 2009

(54) Direct Message Playback and Recording Apparatus and Method

(76) Inventor: Howard M. Katz, Rexford, NY (US)

Correspondence Address: LAW OFFICE OF JAY R. YABLON, 910 NORTHUMBERLAND DRIVE, SCHENECTADY, NY, 12309-2814, US

(21) Appl. No.: 12/390,638

(22) Filed: Feb. 23, 2009

Related U.S. Application Data
(60) Provisional application No. 61/032,350, filed on Feb. 28, 2008.

(51) Int. Cl. G10L 11/00

(52) U.S. Cl. 704/272; 704/E11.001

(57) ABSTRACT

A sound recording and playback apparatus and associated method, comprising: an audio storage medium; a microphone; a speaker; and a plurality of direct message access buttons, each direct message access button simultaneously associated both with a particular pre-recorded sound sequence stored in the storage medium, and with a particular new sound sequence capable of being recorded into the storage medium; wherein: when a particular direct message access button is depressed in a manner which respectively designates pre-recorded playback, new sound sequence recording, or new sound sequence playback, the particular pre-recorded sound sequence associated with the particular direct message access button is respectively audibly played over the speaker or recorded into the storage medium, as appropriate.

### CROSS-REFERENCE TO RELATED APPLICATIONS

This application claims priority benefit of pending provisional application U.S. 61/032,350 filed Feb. 28, 2008.

### BACKGROUND OF THE INVENTION

There are many activities in which humans engage where it is helpful to have available concise audible “reminder” or “tip” messages as they proceed. For example, not limitation, in the sport of golf, there are many instructive “tips” a golfer must remember in terms of the stance to assume, how to draw and swing the club, where to place the ball in relation to the body, how to position the legs in relation to the shoulders, and so on. This, in turn, varies for different types of shot, for example, tee shots, bunker shots, pitch shots, fairway shots, putting, rough shots, etc.

When a golfer is practicing with an instructor present, the instructor, before each practice swing, will often coach the golfer with suitable tips, and in response, the player will often render an effective practice hit in part because of the immediate coaching. But, the instructor will not as a rule accompany the golfer to the golf course. There, the golfer is on his or her own, and must take it upon him or her self to mentally go through each of the tips that he or she heard from the instructor, before making each shot. Often, the golfer will not have the right discipline to do so, and so the golfer's performance on the course without the instructor, will not rise to the level of performance during practice with the instructor.

To provide suitable mental tips, golfers will sometimes carry written notes with them onto the golf course, to review just before taking a shot. Or, they may actually bring along golfing books or guides, and refer to these as they are about to take a shot. This, however, is cumbersome, and may slow the pace of play to an unacceptable level in a sport where the etiquette of maintaining play pace is important.

Absent the physical presence of an instructor, it is desirable to nonetheless hear audible cues from the instructor just before a hit, commensurate with the message an instructor would give had they been present on the course with the golfer.

Additionally, for golf as with other human activities, there are both generic tips that may be helpful, as well as customized tips that apply to the particular individual. For example, a generic tip message about how to hit a bunker shot from the sand may be insufficient to remind the player about particular problems that player has in making sand shots. That person may halt right as the club face strikes the ball, and need a special reminder to follow through. Thus, it is desirable to be able to hear not only a generic message in relation to the activity underway, but also a customized message, oriented toward that particular player/user in relation to those aspects of play for which they need the most assistance. Such message can even be recorded by that player's golf instructor, and then brought to the golf course to provide audible tips right when they are most needed.

Thus, for the example of a golfer, it is desirable to have a sound recording and playback apparatus which can carry both generic (pre-recorded) and personalized (newly-recorded) messages with respect to various type of golf shots, and it is desirable for these messages to be easily accessible. And for other activities, a parallel apparatus with both generic and customized messages, easily accessible, is desirable.

Further, it is desirable for the golfer to be able to retrieve and listen to these messages easily and instantly, by obtaining only the particular message that the user wishes to hear without having to scroll past any other messages which are not presently pertinent.

Further, it is desirable for the apparatus which achieves this functionality, to be light and portable and easy to use without slowing the pace of play.

Finally, it is apparent that such a device can be applied to many other activities in which humans engage where it is helpful to have available concise audible “reminder” or “tip” messages as a person proceed with such activity. This includes many other sports, as well as activities such as diet, exercise, anxiety relief, blood sugar management, health management in general, and a host of other uses for activities where instruction or a reminder or tip would enhance the performance of that task by the user.

Pre-grant publication US 2007/0191127 A1 appears to disclose a device to record and play personalized messages pertaining to specific golfing techniques and situations. However, this publication does not disclose or suggest or motivate providing any sort of generic, pre-recorded message as specified above, in combination with these personalized messages. Nor is there any disclosure, suggestion, or motivation as to how one might make both a generic and a personalized message easily accessible on a single button. On the other hand, a so-called “Talking CPR Flashlight,” marketed over the internet at the link http://www.fulloflife.com/website/store/promotion.asp?item_no=73038&entry=froogle&source code.RFL00000, appears to provide only generic, pre-recorded messages pertaining to CPR, but does not disclose, suggest or motivate providing personalized user messages, or, again, how to easily combine accessibility to both generic and personalized messages. In addition, this Talking CPR Flashlight appears from other links found by a Google Search for “CPR Flashlight,” to have first been sold in June 2008, and there is no apparent public record of any publication or patent application relating to this device prior to June 2008. So, it appears as if applicant's priority application U.S. 61/032,350 filed Feb. 28, 2008 may in any event disqualify this Talking CPR Flashlight, with its generic, pre-recorded messages, as a prior art reference.

In all events, it is desirable to provide an apparatus which can play both generic (pre-recorded) and personalized (newly-recorded) reminder or “tip” messages, with respect to various types of activities, of which golf is but one example. And, it is desirable that these messages be easily accessible by the press of a single button.

### SUMMARY OF THE INVENTION

Disclosed herein is a sound recording and playback apparatus and associated method, comprising: an audio storage medium for storing recorded sound; a microphone for recording specific sound sequences into the storage medium; a speaker for audibly playing specific sound sequences stored in the storage medium; and a plurality of direct message access buttons, each direct message access button simultaneously associated both with a particular pre-recorded sound sequence stored in the storage medium, and with a particular new sound sequence capable of being recorded into the storage medium; wherein: when a particular direct message access button is depressed in a manner which designates pre-recorded playback, the particular pre-recorded sound sequence associated with the particular direct message access button is audibly played over the speaker; when a particular direct message access button is depressed in a manner which designates new sound sequence recording, sounds entering the microphone are recorded into the storage medium in association with the particular depressed direct message access button as a new sound sequence; and when a particular direct message access button is depressed in a manner which designates new sound sequence playback, the particular new sound sequence associated with the same particular direct message access button is audibly played over the speaker.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 is a plan illustrating front, back and side views of a direct digital message access playback device with (or without) over-recording feature in accordance a preferred embodiment.

### DETAILED DESCRIPTION

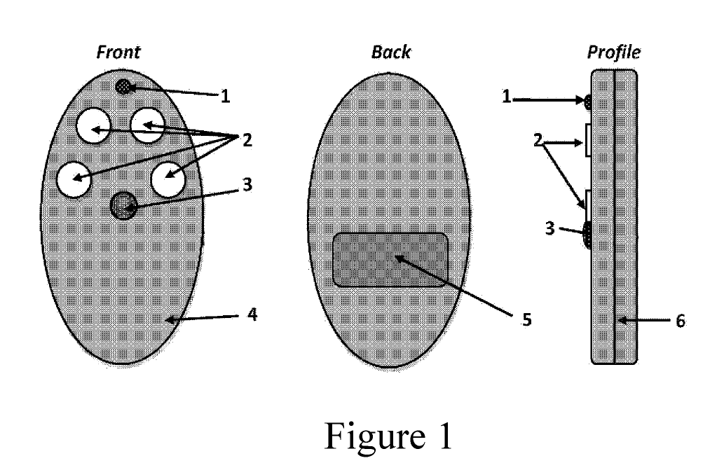

FIG. 1 illustrates the following features of the invention, in a preferred embodiment:

Mini-microphone 1 is used to (optionally) record messages on any of the assignable micro-chips. Plastic, ceramic, or polymer materials typically used in electronics are preferably employed.

Direct Message Access (DMA™) buttons 2 are depressed and pre-recorded messages are played back. It is highly preferred for these pre-recorded message to be non-erasable by the user, and that it be made difficult or impossible for the user to overwrite a pre-recorded message with a different message. This may be facilitated by making it not possible for the user to use the DMA™ buttons to erase or modify pre-recorded messages. It may, however, be desirable to enable factory or trained-technician upgrading of these pre-recorded messages. Button(s) 2 may be colored, numbered or shaped to allow user easy I.D. of message content. Also, button position can denote message content. The number of buttons may be varied within the scope of the invention. The buttons 2 are preferably made from plastics/polymers suitable for injection molding, or similar processes. Each button 2 accesses a memory chip of sufficient size capacity to allow recording, or re-recording, in addition to playback as noted above. The chips are either able to hold the original pre-recorded messages supplied with the unit in memory, or optional user-recordable messages. The chips (or one single integrated chip) are specifically designed for this application, and customized, electronically, to make both pre-recorded and user-recorded messages accessible via the DMA™ buttons.

Audio speaker area (position and size can vary based on the form a specific case-design or application may call for) comprises a speaker 3 which is preferably acoustic or micro-piezo in nature. Stored recorded messages are converted to audible sound and volume is modulated by moving the unit closer to or away from ear. An optional volume control (not shown) may be employed as well. In the absence of a volume control, volume can still be modulated by the user, by covering the speaker area with a thumb or finger-tip. Materials comprise standard acoustic materials, or electronic plastics/polymers or other material suitable for electronic devices.

Unit case 4 is illustrated with an oval shape. However, within the scope of this disclosure, case shape and button locations may vary dependant on specific use of the device by a target user group. A key ring (not shown) is optional. Case 4 is made from plastics, polymers, or other materials suitable for injection molding or similar processes. Case 4 may also be shrink-wrapped with a plastic for texture and artwork application.

Battery access plate 5 provides access to the lithium ion cells, or rechargeable cells, or other suitable equivalents including alkaline watch-size cells. Snap closure or screws are used to secure the opening. Materials are preferably the same as those used for case 4.

By way of example, not limitation, case split seam 6 permits case 4 to be opened by separating along this snap-lock seam. The case also may be secured to itself with screws, eliminating the snap-lock seam feature, and is dependent on the form and manufacturing that the particular application may take.

When the unit is used in play-back mode, a direct message access button 2 accesses the message the user would like to hear. The message plays back through the speaker 3, and the volume of the play back is modulated by moving the unit toward or away from the user's ear, or general area of the ear, and/or by adjusting an optional volume control.

In order to record or over-record a message, the DMA™ button 2 is depressed in a suitable manner as will be further elaborated below. The user then speaks into the microphone 1, and modulates volume by moving the unit closer to or away from the microphone. Once the recording is completed (length from 1 second to 60 seconds or longer, depending on the micro-chip capacity), the button(s) 2 will be released. The unit can have the direct-message-access buttons 2 on top of the unit, the back, sides, or a combination of both. Audible messages can be played back via a small built-in speaker or micro speaker 3 similar to the speaker in a cell phone. The shape of the unit can be modified to fit into the palm of a user's hand, or large enough to extend past the palm or finger tips. By virtue of the foregoing, such a unit is clearly light and portable and handheld. The shape can also be modified to replicate an identifiable object that is typically associated with a particular activity. By example, the unit may be shaped in the form of a golf-ball tee, or a golf ball, square sugar cube, or take on the visual appearance of an item that is uniquely associated with the activity for which the invention is employed.

The unit can also have a key-chain ring built into it to allow for securing the unit to a key ring, neck strap, or other personal connection device. A belt clip may also be employed, that would be either molded to the case, or built into a holster-type apparatus into which the unit fits.

The user can record messages for different purposes, such as reminders for golf instruction, diet and exercise tips, anxiety relief, blood sugar management tips, similar health reminders, and a host of other uses for activities where instruction or a reminder would enhance the performance of that task by the user.

In sum, this is a hand held electronic device for the direct access and play-back of pre-recorded messages. Push buttons mounted on the face of the unit, directly access micro-chip recording devices that may or may not have a recorded message. Each button accesses a different message. Also, through circuitry, users can re-record the messages, or record new messages, and access them via the same buttons. The re-recording function is optional.

The objective of invention is to make access to electronic messages streamlined by providing specific push buttons (or touch pad buttons) that can playback pre-recorded messages without having to scroll through other sequentially imprinted recorded messages.

Recording and playback functionality is achieved directly through the manner in which the user depresses the direct message access buttons 2. For example, not limitation, suppose there are four (4) direct message access buttons 2 as illustrated, each identifying/associated with its own message content as disclosed above, and that these messages are pre-recorded messages, also as disclosed above. In this instance, the instruction provided to the user with this invention might say something to the effect that “to play any one of the four pre-recorded messages, press the associated DMA™ button for about 1 second, and then release. The associated pre-recorded message will then play for the user to hear.”

Then, suppose the user wishes to record new messages, as disclosed above, without overwriting the pre-recorded messages. The user might then follow instructions which say, in effect, that “to record an additional message in association with a particular DMA™ button, press and hold that DMA™ button until you hear (or see) a signal (e.g., two tones) to start recording. Then, record your message, and when you are finished, release the DMA™ button. If your message has been successfully recorded, you will hear (or see) a confirmation signal.” Note, the signal may be audible as described, or visual, for example, employing a light (not shown) which flashes a discrete number of times.

Now, suppose the user wishes to play back a new message previously recorded in association with a particular DMA™ button. For example not limitation, the instruction for this may be, in effect, that “to play back a new message that you have previously recorded, press and hold that DMA™ button until you hear (or see) a signal (e.g., one tone) to start playback. Immediately release that DMA™ button (before the second tone to start recording), and your new message will be played back.

Finally, if the user wishes to re-record over one of the new messages previously recorded by the user, the user follows the same instructions outlined above to record new messages.

It will be apparent that this method of playing back and recording messages can be varied within the scope of this disclosure and its associated claims. For example, not limitation, one can flip the DMA™ button sequence for playing the new message versus the pre-recorded message, such that the new message is played following a “press and release” and the pre-recorded message is played back following a “press and hold until receiving one signal.”

Thus, there are pre-recorded messages (which preferably cannot be erased), new messages which the user can record and then play back, and re-recorded messages which over-record an earlier new message recorded by the user. Consequently, each DMA™ button carries an association with two messages: a pre-recorded message, and a new message recorded by the user which can be over-recorded as desired. The sequence of depressions and (audible or visual) signals noted as examples above, enable the user to play and or record as desired, and to choose which message is played back.

In sum, the invention comprises a plurality of direct message access buttons (with four buttons being the example given here), each direct message access button simultaneously associated a both with a particular pre-recorded sound sequence (e.g., a generic, pre-recorded message), and with a particular new sound sequence (e.g., a user customized message). When a particular direct message access button is depressed in a manner (e.g., depress then release) which designates pre-recorded playback (e.g., playback of the generic message), that message is audibly played over the speaker. When a particular direct message access button is depressed in a manner (e.g. depress and hold till after you hear two beeps) which designates new sound sequence recording (e.g., recording of a user-customized message), sounds entering the microphone are recorded in association with that particular depressed direct message access button. Finally, when a particular direct message access button is depressed in a manner (e.g. depress and hold till after you hear one beep) which designates new sound sequence playback (e.g., playback of the user-customized message), the particular new sound sequence associated with the same particular direct message access button is audibly played over the speaker.

Now, we turn to a review of some related aspects of the design and operation of the invention.

The design/use objective of invention is to make access to electronic messages streamlined by providing specific push buttons (or touch pad buttons) that can playback either pre-recorded factory messages or user-recorded messages without having to scroll through other sequentially imprinted recorded messages.

The shape of the unit can be modified to fit into the palm of a user's hand, or large enough to extend past the palm or finger tips. The underside shape of the unit, in final form, should be preferably be contoured to fit the palm of the hand.

While the number of buttons may be varied, for the four (4) button embodiment, four (4) push buttons mounted on the face of the unit, directly access factory, pre-recorded messages. An e.g., 10-second message related the product market/user interest, is factory pre-recorded onto each of the button-associated micro-chips. Each of the four (4) DMA™ buttons will play one (1) different, e.g., 10-second, pre-recorded message. While a ten second message is preferred, a message of up to 60 seconds (or more) is regarded to be within the scope of this disclosure and its associated claims, including messages of up to 15, 20, 25, 30, 35, 40, 45, 50, 55 and 60 seconds. It may also be desirable in some applications to have other numbers of DMA™ buttons besides four (4), including 2, 3, 5, 6, 7, 8, 9, 10, 11, and 12. A useful number of buttons for many applications will run from 3 to 6.

The device should also enable a user to record a new, e.g., 10-second message (or up to 60 seconds as discussed above), and to be able to access these new messages using the same DMA™ buttons that play back the factory pre-recorded messages, as outlined earlier.

The factory-set recording volume should be approximately 30 to 45 db, though this may be varied and may be coupled with an optional volume control for recording and/or playback volume.

Optionally, the device can include the ability to reset the unit to factory conditions, i.e., to erase all new messages recorded by the user and restore to the state of all pre-recorded messages as they existed at the time the unit was purchased. As noted above, it is also desirable to provide a means whereby a technician can change the factory pre-recorded messages, but where it is difficult or impossible for the user to do so.

It is desirable for the user-recorded messages to be preserved between battery changes, as well as for a minimum of two months if the unit is inactive. Optionally, an audible “beep” alarm can be programmed into the circuitry to warn of the need for battery replacement. However, it should be possible for the unit to power down, and be inoperative, at a point in time when the battery voltage reaches the minimum micro-chip power requirements to still allow for the long-term, user-recorded messages to be saved.

It is preferred that the unit be able to operate continuously for at least two to five hours between battery changes.

As noted above, each DMA™ button will play, from the factory, one e.g., 10-second pre-recorded message, for a total of four (4) factory pre-recorded messages per unit, for the 4-button embodiment. Also, each DMA™ button must be able to record one (1) additional, e.g., 10-second user-recorded new message that may be played in lieu of or in addition to the factory-recorded messages. Therefore, for the four (4) button embodiment, there are four (4) user-recorded messages per unit, and four (4) pre-recorded messages per unit, comprising one pre-recorded message and one user-recorded message per button.

The case shape and button locations may vary from the FIG. 1 illustration, dependent on the specific use of the device by a target user group. The shape of the unit should be contoured to fit the hand, and so is preferably rounded as illustrated. Optionally, the open area on the face of the unit should be left plain, and not perforated or otherwise interrupted, to allow for post-production application of various advertising logos.

The case itself may be fabricated from plastic or other polymers, for example but not limited to an ABS™ type material. All multi-function DMA™ buttons, preferably, are of different colors, though this is not required.

Finally, we examine some particular applications of this invention which, while not limiting, are exemplary of the wide range of applications for which this invention may be used.

A first envisioned use, is to provide reminders for golf instruction. In one embodiment, the four DMA™ buttons are associated, respectively, with “bunker shot,” “tee shot,” “pitch shot” and “fairway shot.” (Putting might be added as a fifth function, in a five-button embodiment.) The pre-recorded messages are generic. For a “bunker shot,” the pre-recorded message might say “ball forward in stance; open feet, hips, shoulders, clubface; focus 2 inches behind ball; swing along foot line; splash the sand and finish swing; focus on rhythm.” For a “tee shot,” the pre-recorded message might say “find interim target; feet shoulder width and parallel; ball position inside front heel; maintain knee flex; focus on rhythm.” For a “pitch shot,” the pre-recorded message might say “choose landing area; light grip pressure; open shoulders and stance slightly; 60% of weight on front foot; swing along foot line; focus on rhythm.” Finally, for a “fairway shot,” the pre-recorded message might say “find interim target; feet inside shoulder width and parallel; personal choice of ball position; swing through to your target; focus on rhythm.” These, it will be observed, are the same things a golfing instructor might tell a student while the student is in practice. In this way, the necessary instructive reminders are available to the player on the course, even without the instructor present to issue reminders before each shot.

Now, the foregoing pre-recorded messages are all generic messages which apply to all golfers. But each individual player will naturally have some aspects of play where they perform well, and others where they tend to be forgetful and perform poorly. Let us suppose that a particular user, in practice, has particular trouble remembering to follow through for bunker shots. The user, or the instructor, might record a new message—which is the second message associated with the “bunker shot” button—which says “do not stop short after you hit the ball but continue your follow through.” Then, before the bunker shot, the user can first play the pre-recorded generic message, and then play the new, second message which is personalized to that user and their particular problems in making bunker shots. As another example, it is common for golfer to over-swing on tee shots, and to provide too much push force from their “rear” arm and not enough pull from their “forward” arm. In this instance, the new personalized message recorded as the second message on the “tee shot” button might say “Jay, make sure to lead with your left arm and do not over-hit the ball. This is golf, not baseball!” Once again, for the tee shot, there is both a pre-recorded message that applies generically to all golfers, along with a new message that is personalized to that particular user and can be changed at will thereafter.

It should be apparent how these sorts of pre-recorded, generic messages, together with new, personalized messages, can be useful in a wide variety of other applications. For example, one can envision how this might readily be applied to sports such as, but not limited to, tennis, baseball and bowling. As another example, it was also noted above that this invention can be used for diet and exercise tips. For diet, one might have messages for “breakfast,” “lunch,” “dinner,” and “snacks,” in a four-button embodiment. Or, there might be messages about various food groups. And, these messages would comprise generic, pre-recorded messages, recorded in association with the same button as customized, personalized messages.

Similarly, as disclosed earlier, other applications might include, for example, not limitation, physical health management activities such as anxiety relief, blood sugar management, medication regimen, similar health reminders, and a host of other uses for activities where instructional tips or reminders, both generic and personalized, would enhance the performance of that activity by the user. One can also envision mental health counseling applications. For example, a person undergoing alcohol or drug recovery may find it helpful at times of weakness to listen to not only generic messages, but also to personalized messages from the soothing voice of their therapist. This invention as disclosed, can contain biblical quotations, or can provide support in an educational or instructional or training environment, for example not limitation, for individuals with learning disabilities. Similar sorts of applications in many other areas not specifically listed here, will also become apparent to persons of ordinary skill in the art, after reviewing this disclosure.

While only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A sound recording and playback apparatus comprising:
an audio storage medium for storing recorded sound;
a microphone for recording specific sound sequences into said storage medium;
a speaker for audibly playing specific sound sequences stored in said storage medium; and
a plurality of direct message access buttons, each direct message access button simultaneously associated both with a particular pre-recorded sound sequence stored in said storage medium, and with a particular new sound sequence capable of being recorded into said storage medium; wherein:
when a particular direct message access button is depressed in a manner which designates pre-recorded playback, the particular pre-recorded sound sequence associated with said particular direct message access button is audibly played over said speaker;
when a particular direct message access button is depressed in a manner which designates new sound sequence recording, sounds entering said microphone are recorded into said storage medium in association with said particular depressed direct message access button as a new sound sequence; and
when a particular direct message access button is depressed in a manner which designates new sound sequence playback, the particular new sound sequence associated with said same particular direct message access button is audibly played over said speaker.

2. The apparatus of claim 1, wherein:
all of said sound sequences are voice recordings comprising messages for a user of said apparatus to listen to while engaging in an activity;
the pre-recorded sound sequence voice recordings comprise messages which are generic in relation to said activity, and not user specific;
the new sound sequence voice recordings comprise messages which are individually customized to the user in relation to said activity; and
each said direct message access button is simultaneously associated both with a particular message which is generic in relation to said activity and with a particular message which is individually customized to the user in relation to said activity.

3. The apparatus of claim 2:
depressing a direct message access button in a manner which designates pre-recorded playback comprising pressing and then releasing said direct message access button before any signal is given by said apparatus;
depressing a direct message access button in a manner which designates new sound sequence recording comprising pressing and holding down said direct message access button until at least a first signal and a second signal are given by said apparatus; and
depressing a direct message access button in a manner which designates new sound sequence playback comprising pressing and holding down said direct message access button until said first signal is given by said apparatus, and then releasing said particular direct message access button before said second signal is given by said apparatus.

4. The apparatus of claim 3, said signals comprising audible signals.

5. The apparatus of claim 3, said signals comprising visual signals.

6. The apparatus of claim 2:
depressing a direct message access button in a manner which designates new sound sequence playback comprising pressing and then releasing said direct message access button before any signal is given by said apparatus;
depressing a direct message access button in a manner which designates new sound sequence recording comprising pressing and holding down said direct message access button until at least a first signal and a second signal are given by said apparatus; and
depressing a direct message access button in a manner which designates pre-recorded playback comprising pressing and holding down said direct message access button until said first signal is given by said apparatus, and then releasing said particular direct message access button before said second signal is given by said apparatus.

7. The apparatus of claim 6, said signals comprising audible signals.

8. The apparatus of claim 6, said signals comprising visual signals.

9. The apparatus of claim 2, wherein it is not possible for the user to use said direct message access buttons to erase or modify said pre-recorded voice recordings.

10. The apparatus of claim 2, wherein each sound sequence stored in said audio storage medium does not exceed 60 seconds in length.

11. The apparatus of claim 2, wherein each sound sequence stored in said audio storage medium does not exceed 15 seconds in length.

12. The apparatus of claim 2, said plurality of direct message access buttons comprising exactly four direct message access buttons.

13. The apparatus of claim 2, said plurality of direct message access buttons comprising at least three and no more than six direct message access buttons.

14. The apparatus of claim 2, said activity comprising a sporting activity selected from the sport group consisting of: golf; baseball; tennis; and bowling.

15. The apparatus of claim 2, said activity comprising an activity selected from the activity group consisting of: diet; exercise; mental health management; and physical health management.

16. The apparatus of claim 2, said activity comprising an activity selected from the activity group consisting of: education; instruction; and training.

17. A sound recording and playback method comprising:
providing a plurality of direct message access buttons;
providing an audio storage medium for storing recorded sound;
providing a microphone for recording specific sound sequences into said storage medium;
providing a speaker for audibly playing specific sound sequences stored in said storage medium;
simultaneously associating each direct message access button both with a particular pre-recorded sound sequence stored in said storage medium, and with a particular new sound sequence capable of being recorded into said storage medium;
audibly playing the particular pre-recorded sound sequence associated with a particular direct message access button over said speaker, responsive to depressing said particular direct message access button in a manner which designates pre-recorded playback;
recording sounds entering said microphone into said storage medium in association with a particular depressed direct message access button as a new sound sequence, responsive to depressing said particular direct message access button in a manner which designates new sound sequence recording; and
audibly playing the particular new sound sequence associated with said same particular direct message access button over said speaker, responsive to depressing a particular direct message access button in a manner which designates new sound sequence playback.

18. The method of claim 17, wherein:
all of said sound sequences are voice recordings comprising messages for a user to listen to while engaging in an activity;
the pre-recorded sound sequence voice recordings comprise messages which are generic in relation to said activity, and not user specific; and
the new sound sequence voice recordings comprise messages which are individually customized to the user in relation to said activity; further comprising:
simultaneously associating each said direct message access button both with a particular message which is generic in relation to said activity and with a particular message which is individually customized to the user in relation to said activity.

19. The method of claim 18:
depressing a direct message access button in a manner which designates pre-recorded playback comprising pressing and then releasing said direct message access button before any signal is given by an apparatus used to practice said method;
depressing a direct message access button in a manner which designates new sound sequence recording comprising pressing and holding down said direct message access button until at least a first signal and a second signal are given by said apparatus; and
depressing a direct message access button in a manner which designates new sound sequence playback comprising pressing and holding down said direct message access button until said first signal is given by said method, and then releasing said particular direct message access button before said second signal is given by said apparatus.

20. The method of claim 19, said signals comprising audible signals.

21. The method of claim 19, said signals comprising visual signals.

22. The method of claim 18:
depressing a direct message access button in a manner which designates new sound sequence playback comprising pressing and then releasing said direct message access button before any signal is given by an apparatus used to practice said method;
depressing a direct message access button in a manner which designates new sound sequence recording comprising t pressing and holding down said direct message access button until at least a first signal and a second signal are given by said apparatus; and
depressing a direct message access button in a manner which designates pre-recorded playback comprising pressing and holding down said direct message access button until said first signal is given by said method, and then releasing said particular direct message access button before said second signal is given by said apparatus.

23. The method of claim 22, said signals comprising audible signals.

24. The method of claim 22, said signals comprising visual signals.

25. The method of claim 18, wherein it is not possible for the user to use said direct message access buttons to erase or modify said pre-recorded voice recordings.

26. The method of claim 18, wherein each sound sequence stored in said audio storage medium does not exceed 60 seconds in length.

27. The method of claim 18, wherein each sound sequence stored in said audio storage medium does not exceed 15 seconds in length.

28. The method of claim 18, said plurality of direct message access buttons comprising exactly four direct message access buttons.

29. The method of claim 18, said plurality of direct message access buttons comprising at least three and no more than six direct message access buttons.

30. The method of claim 18, said activity comprising a sporting activity selected from the sport group consisting of: golf; baseball; tennis; and bowling.

31. The method of claim 18, said activity comprising an activity selected from the activity group consisting of: diet; exercise; mental health management; and physical health management.

32. The method of claim 18, said activity comprising an activity selected from the activity group consisting of: education; instruction; and training.
